(19) United States
(12) Patent Application Publication
(10) Pub. No.: US 2004/0220903 A1
(43) Pub. Date: Nov. 4, 2004

(54) Method and system to correlate trademark data to internet domain name data

(75) Inventors: Faisal Shah, Boise, ID (US); James L. Hepworth, Boise, ID (US); Kelly James Riley, Boise, ID (US)

Correspondence Address: Mr. Eric S. Chen, PILLSBURY WINTHROP LLP, Suite 2800, 725 South Figueroa Street, Los Angeles, CA, 90017-5406, US

(73) Assignee: EMARKMONITOR INC., Boise, ID (US)

(21) Appl. No.: 10/427,194

(22) Filed: Apr. 30, 2003

(51) Int. Cl. G06F 17/30; G06F 7/00

(52) U.S. Cl. 707/3

(57) ABSTRACT

A system to correlate trademark data to Internet domain name data includes a user system having a user interface. A host system is in communication with the user system. The host system executes a software application adapted to receive a name of a trademark owner. The software application creates a search string including at least the name of the trademark owner, and searches for trademarks owned by and assigned to the trademark owner based on the search string. The software application generates a trademark list including the located trademarks owned by and assigned to the trademark owner. The software application generates domain names corresponding to the trademark list, and identifies whether the domain names generated are available for registration.

### BACKGROUND OF THE INVENTION

1. Field of the Invention

The present invention relates to the contemporary issue of unauthorized use of trademarks on the Internet. More specifically, the present invention applies to software that correlates trademark data, such as ownership data, with data regarding registered and unregistered Internet domain names.

2. Discussion of the Related Art

Currently, there is widespread misuse of trademarks in Uniform Resource Locators (URLs) that contain registered domain names on the Internet. Certain people and companies wrongfully register trademarks as domain names for the purpose of, among other things, holding the domain names for ransom from the rightful owner of the marks (sometimes referred to as the practice of “cybersquatting”), or, diverting Internet traffic from the legitimate Web site of the owner of the mark to an infringing or unauthorized Web site.

The currently available method of uncovering marks that have been registered as domain names on the Internet is as follows: (1) First, each mark owned by a specified person or company must be determined through the use of publicly available trademark databases, such as the U.S. Patent and Trademark Office's (USPTO) Trademark Electronic Search System (TESS); (2) Second, each mark must be entered into a search engine (e.g., Google™ and Yahoo!™) available on the Internet, or the Network Solutions™ WHOIS database must be used to search whether such a mark is present as a registered domain name in the General Top Level Domain (gTLD) listings; (3) Third, each Country Code Top Level Domain (ccTLD) database must be searched in order to find the presence of such a mark as a ccTLD name; and (4) Fourth, each available domain must be registered as a domain name if such URLs are available through an accredited domain name registrar.

Simply searching for a mark via Internet search engines, e.g., (2) above, is painstakingly slow, and does not necessarily reveal all of the misuses in existence, as not all registered domain names are indexed with search engines. Further, the remaining method of searching the gTLD and ccTLD databases, e.g., (3) above, must be individually conducted for each mark. In addition, each variation (such as a misspelling, abbreviation, or plural version) of a mark must also be searched. As there are currently almost 300 ccTLD databases, in addition to the Network Solutions™ WHOIS database, conducting searches of these databases for each mark is daunting for intellectual property owners. Once it is determined which marks a user desires to protect, the user must manually contact a domain name registrar to register each mark as a domain name. Further, such searching must be conducted on a regular basis as: (i) domain names are added to the gTLD and ccTLD databases daily; and (ii) domain names may expire on a daily basis. The confusing and burdensome nature of the above-described procedures results in fewer domain name registrations by mark owners, thereby creating opportunities for misuse by cybersquatters.

Thus, in order to meet the statutory policing requirements, it is advantageous to provide an efficient method and system for correlating trademark data to Internet domain name data, which may alleviate the burdensome and flawed method of searching which is currently available to trademark owners.

### BRIEF DESCRIPTION OF THE DRAWINGS

FIG. 1 illustrates a system for correlating trademark data to Internet domain name data according to an embodiment of the present invention;

FIG. 2 illustrates a system for correlating trademark data to Internet domain name data according to a further embodiment of the present invention;

FIGS. 3A and 3B illustrate a flow chart diagram of an exemplary search according to an embodiment of the present invention;

FIG. 4 illustrates a system for correlating trademark data to Internet domain name data according to another embodiment of the present invention; and

FIG. 5 illustrates a flow chart diagram of correlating trademark data to Internet domain name data according to an embodiment of the present invention.

### DETAILED DESCRIPTION

The detailed description set forth below in connection with the drawing figures is intended as a description of the presently preferred embodiment of the invention, and is not intended to represent the only forms in which the present invention may be constructed or utilized. The description sets forth the apparatus, method, system, and software program in connection with the illustrated embodiment. It is to be understood, however, that the same or equivalent functions may be accomplished by different embodiments that are also intended to be encompassed within the spirit and scope of the invention.

The present invention specifically addresses and alleviates the above-identified deficiencies in the art. The present invention is directed to providing a fast and effective method and system of policing and protecting marks in domain names of the Internet. The present invention applies to software that correlates trademark data, such as ownership data, with data regarding registered and unregistered Internet domain names. Specifically, such correlating software enables the user to obtain a complete list of the trademarks, service marks or logos (hereinafter “mark” or “marks”) owned by a specified person or entity, and matches such list against the available and/or registered domain names incorporating such marks. More specifically, the present invention may be used by a trademark owner to identify whether its marks are being properly used or misused by third parties. The present invention assists trademark owners in policing their intellectual property, as required by trademark law, and protecting their marks by registering their marks as domain names in the event such domain names are available for registration.

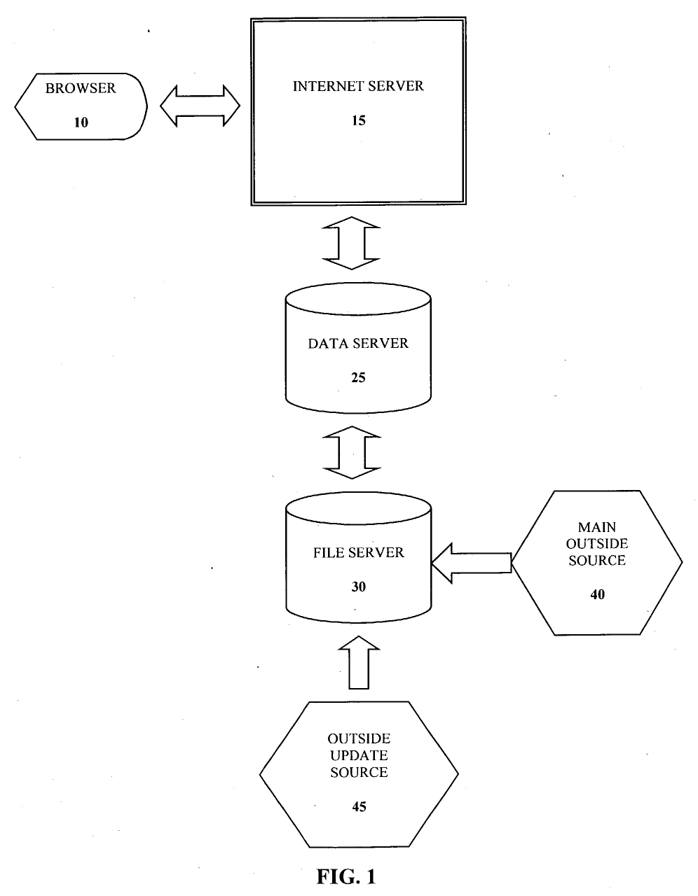

FIG. 1 illustrates a system for correlating trademark data to Internet domain name data according to an embodiment of the present invention. In particular, FIG. 1 illustrates the interconnections and communications between a Browser 10, an Internet Server 15, a Data Server 25, a File Server 30, a Main Outside Source 40, and an Outside Update Source 45.

The present invention provides a system for the user to identify all marks owned by a trademark owner (the Target), and then compare the trademark results obtained to registered domain names. One or a plurality of client database servers, such as the Data Server 25, is provided wherein the database servers store information of searching activity, including the identity of the user, the identity of the Target, the identity of trademarks identified as belonging to the Target, and domain names identified along with related domain database information generated from a root zone file or other means.

One or a plurality of trademark database servers, e.g., part of the Main Outside Source(s) 40, containing current USPTO and/or international and/or state database data (which may also include ownership/assignment data) is accessed. The trademark servers are connected, directly or indirectly, to the client database servers such as the Data Server 25. One or a plurality of domain name database servers, e.g., part of the Main Outside Source(s) 40 or Outside Update Source(s) 45, is provided containing current gTLD and ccTLD domain database information. The domain name servers are also connected, directly or indirectly, to the client database servers (such as Data Server 25) and trademark servers.

Preferably, the apparatus further includes one or a plurality of registry servers to transmit domain name registration information to the appropriate registrar systems for registration of gTLDs and ccTLDs. Also, the apparatus preferably further includes encryption capabilities for communication between the Internet Server 15 (e.g., user server) and the Data Server 25.

Preferably, the Data Server 25 communicates with the Internet Server 15 (e.g., user server(s)) via an Internet Web site. Additionally, the apparatus preferably further includes one or a plurality of variation database servers that have a software program to determine a plurality of homonyms and phonetic equivalents (the Variations) of a particular trademark term to be searched, or of a name of a trademark owner or assignee.

A Browser 10 (such as Microsoft Internet Explorer™) and the Internet Server(s) 15, which includes a computer server with suitable processing power and memory, receives and responds to requests for access through the Browser 10. Internet Servers 15 are preferably capable of rapidly performing database queries, as well as handling input and output needs. A Sun Microsystems® 300 MHz UltraSparc® II processor is one example of a CPU that may be used. A similar processor, such as a 550 MHz Compaq) Alpha 21164, or a 550 MHz Intel® Pentium® III may also be used. These processors are listed only as examples, and any suitable processor device may be utilized.

A Data Server 25 is connected to a File Server 30, and the Internet Server 15, which may communicate with the Browser 10. The Data Server 25 stores data regarding the user or client, as well as the data files generated by the File Servers 30 during the trademark searching process. Data storage device(s) used in the Internet Servers 15, Data Servers 25 and File Servers 30 preferably include storage media such as hard disk magnetic storage, magnetic tape, or CD-ROM/DVD-ROM (optical) drives. Data storage device(s) include databases used in the processing of transactions in the present invention. File Servers 30 receive data from the Main Outside Source(s) 40 and the Outside Update Source(s) 45. Main Outside Sources 40 includes database files from outside information sources (such as the USPTO trademark database, ccTLD databases, etc.). Outside Update Sources 45 include database files from outside information sources that update or add to the database files received from the Main Outside Sources 40. Outside Update Sources 45 include top-level domain data from databases of top-level registries, such as Verisign/Network Solutions™, Afilias™, etc.

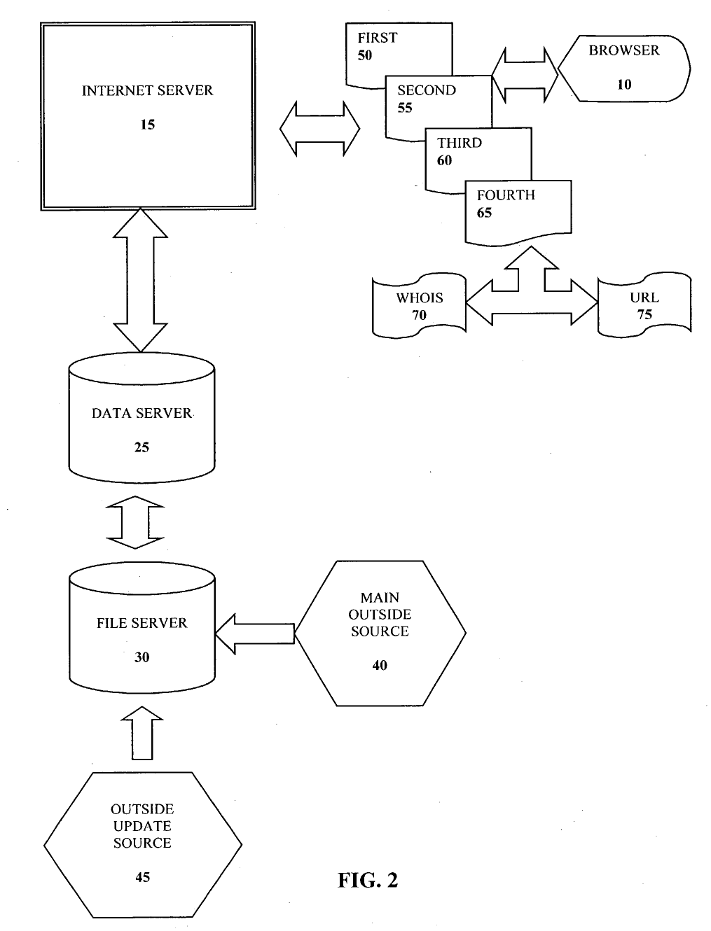

FIG. 2 illustrates a system for correlating trademark data to Internet domain name data according to a further embodiment of the present invention. File Servers 30 include annual and updated data from one or more Main Outside Sources 40 and Outside Update Sources 45. File Servers 30 are connected to one or more Data Servers 25, which receive and store data files generated by the File Servers 30. Upon a command by a user, via for example, the Browser 10, the File Servers 30 may be accessed. Parsing applications are executed to parse the files contained in the File Servers 30 for the requested information. Data files are created that are sent and stored in the Data Servers 25. The Browser 10 accesses the Data Servers 25 to obtain the requested information that is used to fill out a First Report Template 50 that is displayed by the Browser 10.

The user may choose one or more trademark owners (Targets) from the First Report Template 50 and may send a command through the Browser 10 to the File Servers 30 to look for trademarks associated with the chosen trademark owners. Parsing applications are executed to parse the files contained in the File Servers 30 for the requested information. Data files that are created are sent and stored in the Data Servers 25. The Browser 10 accesses the Data Servers 25 to obtain the requested information that is used to fill out a Second Report Template 55 that is displayed to the user by the Browser 10.

The user may choose at least one trademark from the Second Report Template 55 and send a command through the Browser 10 to the File Servers 30 to search for domain names containing the chosen trademarks. Parsing applications are executed to parse the files contained in the File Servers 30 for the requested information. The data files that are created are sent and stored in the Data Servers 25. The Browser 10 accesses the Data Servers 25 to obtain requested information that is used to fill out a Third Report Template 60 that is displayed to the user by the Browser 10.

The user may choose one or more domain names from the Third Report Template 60 and send a command through the Browser 10 to the File Servers 30 to look for domain database information and URL data associated with the chosen domain names. Parsing applications are executed to parse the files contained in the File Servers 30 for the requested information. The data files that are created are sent and stored in the Data Servers 25. The Browser 10 accesses the Data Servers 25 to obtain the requested information that is used to fill out a Fourth Report Template 65 that is displayed to the user via the Browser 10. From the Fourth Report Template 65, the user may view the domain database information data 70, and/or access and crawl the URL address 75 to access a Web page.

According to a further embodiment of the present invention, the Third Report Template 60 additionally generates and provides suggested domain names that the user may wish to register. Suggested domain names may be provided by software programs which recognize and concatenate common words, provide abbreviations or acronyms, or suggest phonetic or homonym equivalents to the user for use as domain names. Other suitable suggestions may be provided, though. A user may select one or more domain name suggestions provided in the Third Report Template 60 and send a command through the Browser 10 to electronically contact a domain name registrar, and purchase and register the selected domain names. The cost associated with the registration of each domain name may be charged on an account of the user via the user's account information stored in the Data Server 25.

According to another embodiment of the present invention, a system for searching and reporting the incidence of at least one domain name containing at least one trademark of a Target includes a computer system having a connection to the Internet and a software program executing on the computer system. The software program is adapted to receive an input of at least one Target, perform a function wherein the software program locates trademarks on the trademark database servers corresponding to the at least one Target. The software program then locates domain name registrations corresponding to the trademark results on the domain name database servers. Once the domain results are obtained, the software program accesses the URL address corresponding to each domain name identified. The Web page of each URL is then crawled for incidences of the corresponding trademark. The software program then provides the Web page search results.

According to yet another embodiment of the present invention, a system for registering all or any portion of the domain results as may be selected by the user as gTLDs and/or ccTLDs (the Requested Domain Names), thereby creating a fourth search string to be transmitted to the applicable registrar systems for registration of the Requested Domain Names by the appropriate registrar.

Preferably, the system further includes a method and system for comparing the trademark results to the variations database servers and concatenating the results to the corresponding trademarks of the trademark results to form search strings used to query the domain name database servers.

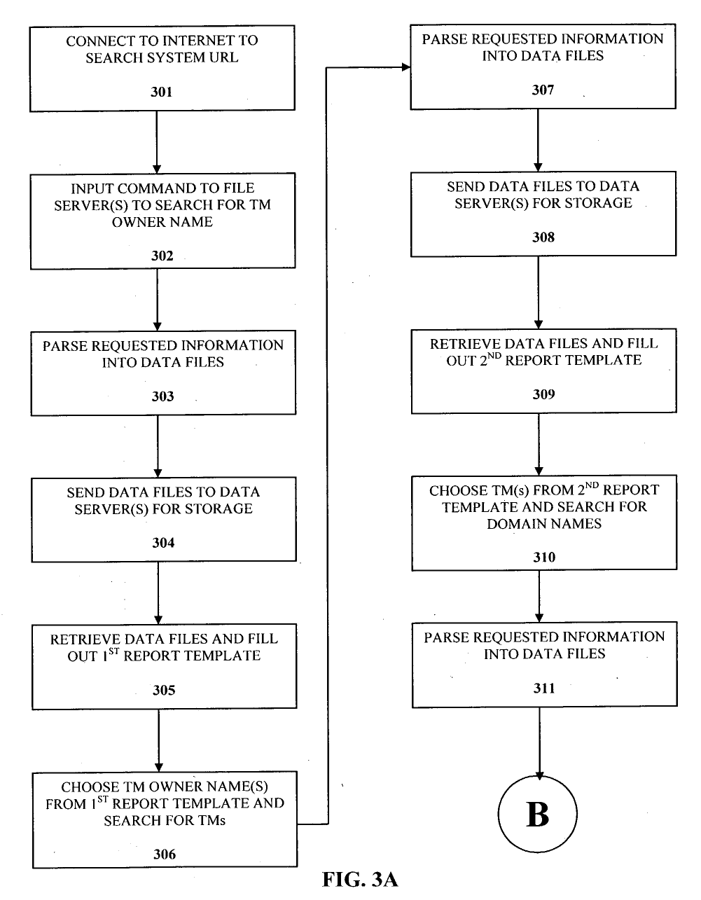

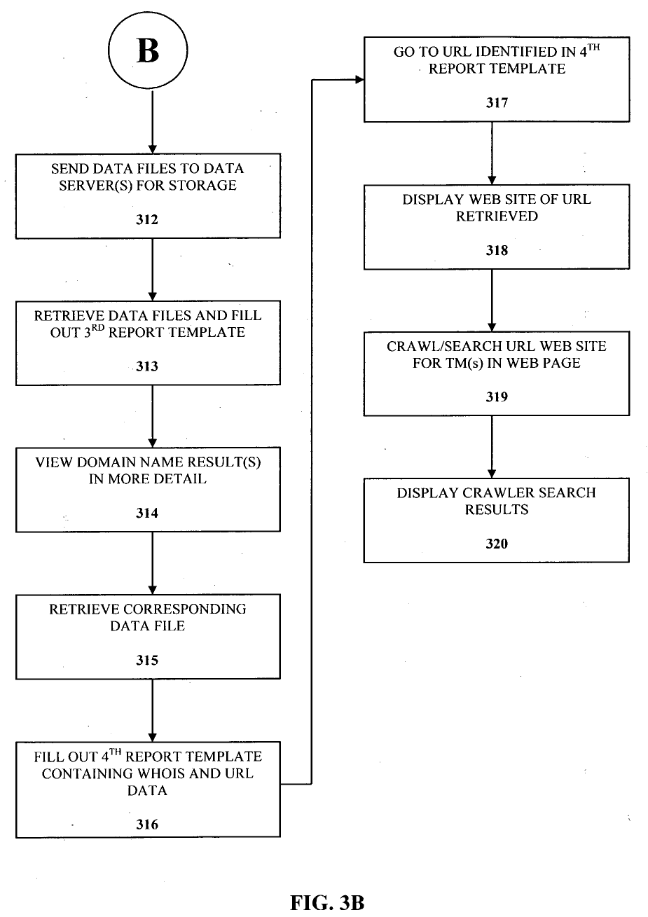

FIGS. 3A and 3B illustrate a flow chart diagram of an exemplary search according to an embodiment of the present invention.

Step 301: The user connects to the Internet via a personal computer and goes to the URL of the Application Server Provider (ASP) of the inventive process.

Step 302: The user inputs a command to the one or more File Servers 30 to look for a trademark owner name. The user selects a database(s) to be searched.

Step 303: The File Server 30 utilizes one or more parsing applications (such as CGI, Perl, C, C++, Java, etc.) to parse the requested information into data files.

Step 304: The File Server 30 sends the data files to one or more Data Servers 25 where the data files are stored.

Step 305: The Browser 10 retrieves the data files and fills out a First Report Template 50 that is displayed to the user.

Step 306: The user chooses one or more trademark owner names from the First Report Template 50 and inputs a command to the File Servers 30 to look for trademarks corresponding to the trademark owner names.

Step 307: The File Servers 30 use parsing applications to parse the requested information into data files.

Step 308: The File Server 30 sends the data files to the Data Servers 25 where the data files are stored.

Step 309: An application server (e.g., Internet server 15) retrieves the data files and fills out a Second Report Template which is displayed to the user on the Browser 10.

Step 310: The user chooses one or more trademarks from the Second Report Template 55 and inputs a command to the File Servers 30 to look for domain names corresponding to the trademarks.

Step 311: The File Servers 30 parse the requested information into data files.

Step 312: The File Server 30 sends the data files the Data Servers 25 where the data files are stored.

Step 313: The Browser 10 retrieves the data files and fills out a Third Report Template 60 which is displayed to the user.

Step 314: The user inputs a command to the Data Servers 25 to view one or more of the domain name results in more detail.

Step 315: The Browser 10 retrieves the corresponding data file from the Data Servers 25.

Step 316: The Browser 10 fills out a Fourth Report Template 65 containing domain database information and/or an URL address for the domain name, which is displayed to the user.

Step 317: The user inputs a command to point the Browser 10 to the URL identified in the Fourth Report Template 65.

Step 318: The Browser 10 opens a new window and displays the URL's Web site to the user.

Step 319: The user inputs a command to crawl/search a selected URL to determine the presence of a subject trademark in the text, hidden text, titles, hyperlinks, detail notes, images and/or meta tags, etc. of the Web site.

Step 320: The search results are displayed to the user within the Web site.

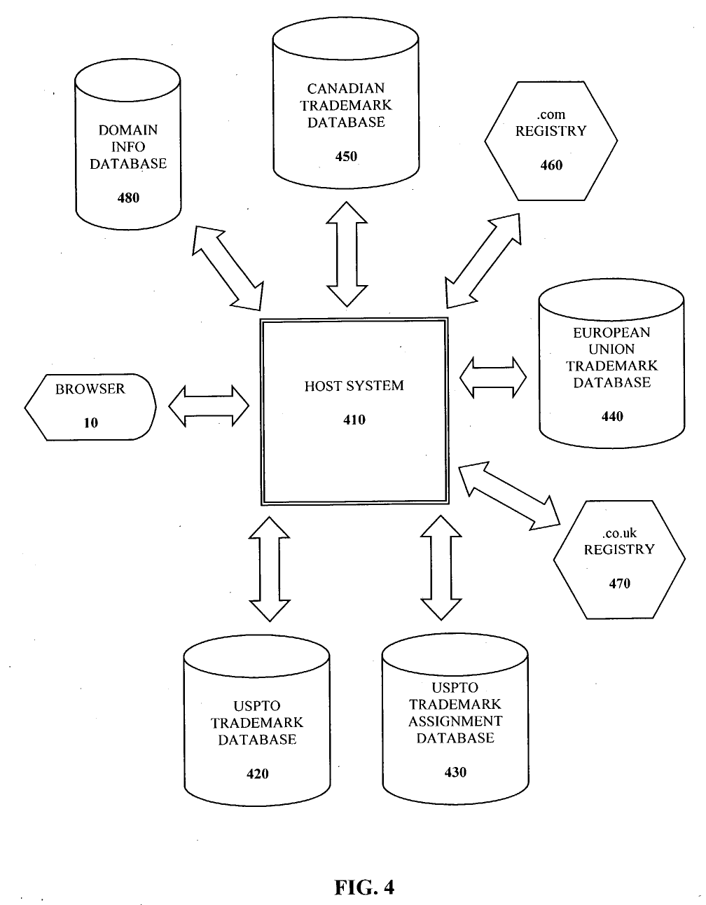

FIG. 4 illustrates a system for correlating trademark data to Internet domain name data according to another embodiment of the present invention. Similarly to FIGS. 1 and 2 above, the browser 10, such as Microsoft Internet Explorer™ or Netscape Navigator™, for example, may be utilized to communicate with a host system 410 hosting the trademark search/reporting service. The browser 10, typically resident on a computer system at the user end, may be connected to a network such as the Internet to communicate with the host system 410. The host system 410 may include any and all of, for example, the Internet Server 15, the Data Server 25, and the File Server 30, as discussed and illustrated above with respect to FIGS. 1 and 2. The host system 410 may provide an interface for the user, for example, in the form of a Web page.

The host system 410 may communicate with a plurality of databases to obtain trademark data, trademark ownership/assignment data, and Internet domain name data. For example, the host system 410 may communicate with the USPTO trademark database 420 to obtain trademark data and trademark ownership data. The USPTO trademark assignment database 430 may be accessed by the host system 410 to obtain assignment data relating to the trademarks registered with the USPTO. Trademarks registered with the USPTO may be subsequently assigned by the original trademark owner to another party, and these assignments are typically recorded with the USPTO and stored in a separate USPTO trademark assignment database 430. The host system 410 may also be configured to access foreign trademark databases as well, such as the European Union trademark database 440 for trademarks registered with the European Office for Harmonization in the Internal Market, or the Canadian trademark database 450 for trademarks registered with the Canadian Intellectual Property Office. Depending upon the specific foreign trademark office, the assignment database may be incorporated within the trademark database, or in a separate database, such as in the United States. The host system 410 is adapted to access any trademark database and trademark assignment database to obtain trademark data and trademark ownership/assignment data in foreign countries that make their databases available.

In addition to accessing trademark data of U.S. and foreign trademark offices, the host system 410 is adapted to access a general Top Level Domain registry 460 (e.g., the .com registry), a country code Top Level Domain (ccTLD) registry 470 (e.g., the .co.uk registry), or the domain information (e.g., WHOIS) database 480 to determine whether a searched for mark is present as a registered domain name.

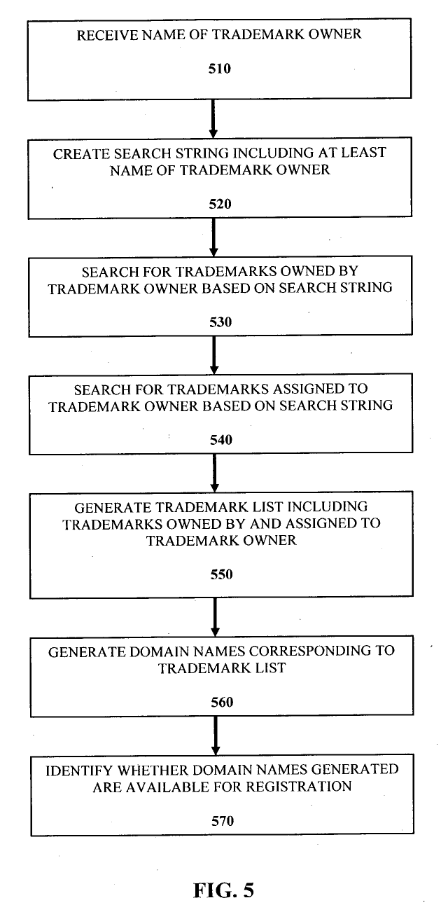

FIG. 5 illustrates a flow chart diagram of correlating trademark data to Internet domain name data according to an embodiment of the present invention. A user may utilize a browser 10, for example, to access the host system 410 through a Web page provided by the host system 10 as a user interface. The user inputs a name of a trademark owner that the user is interested in searching for trademarks owned by/assigned to that trademark owner, and the host system 410 receives 510 the name of the trademark owner through, for example, the Web page, or another suitable user interface. The host system 410 creates 520 a search string that includes at least the name of the trademark owner for searching trademark databases. The search string may include variations of, for example, the spelling of the trademark owner as well. In some instances, a name of a trademark owner may reveal multiple entities sharing the same name, of which may be related or unrelated entities. The host system 410 may then prompt the user to select one or more trademark owner entity (entities) from the plurality of entities containing the same name or word(s) to continue the trademark search. Alternatively, according to an embodiment of the present invention, if the user does not know the name of a trademark owner, but has knowledge of other information, for example, such as the address of the trademark owner, a corporate officer or employee, the primary place of business, etc., the user may provide any of this information to the host system 410 and the host system 410 may conduct a search to provide names of potential trademark owners corresponding to the information provided by the user to help the user select a trademark owner from the names of potential trademark owners located by the host system 410 that best matches the information provided.

The host system 410 searches 530 in the trademark database 420 for trademarks owned by the trademark owner selected by the user. Additionally, the host system 410 searches 540 for trademarks assigned to the trademark owner selected by the user. A trademark list is generated 550 by the host system 410 that includes the trademarks owned by the trademark owner and the trademarks assigned to the trademark owner that are located by the above database searches. The host system 410 may also search for and identify homonyms and phonetic equivalents of the located trademarks owned by the trademark owner for inclusion in the trademark list. Similarly, the host system 410 may also search for and identify homonyms and phonetic equivalents of the located trademarks assigned to the trademark owner for inclusion in the trademark list as well.

The USPTO maintains a database 420 containing trademark data such as the trademark itself (e.g., the word mark), original owner, classification code, short description, and serial number. However, the USPTO maintains a separate assignment records database 430 that includes, for example, the serial number of a trademark registration, along with its frame/reel number of recordation. Accordingly, searching the assignment database 430 for a trademark, i.e., a word mark, assigned to a particular assignee is not readily easily accomplished because only the serial number of the trademark, and not the trademark itself, i.e., word mark, is recorded and stored in the assignment database 430.

Therefore, according to an embodiment of the present invention, after searching in the trademark database 420 for trademarks owned by the trademark owner in question, the assignment database 430 is also searched to determine whether the original owner of the trademarks is the current owner, or if the trademarks have been assigned away to another party. Those trademarks determined to have been assigned to another party are no longer owned by the original owner, and therefore may be omitted from the trademark list as being a trademark currently owned by the trademark owner in question.

When the assignment database 430 is searched for trademarks assigned to a particular entity, the name of the entity may be located in the assignment database 430 corresponding to serial numbers of trademarks assigned to that entity. Based on the serial number(s) obtained by the host system 410 from the assignment database 430 that correspond to the name of the trademark owner to be searched, the host system 420 searches the trademark database 420 based on the serial number(s) obtained from the assignment database 430 to determine the actual trademarks, i.e., word marks, corresponding to the located serial number(s) that have been assigned to the name of the trademark owner in question. Accordingly, based on this “reverse look-up” method, trademarks (i.e., word marks) assigned to the name of the trademark owner in question may be readily located by the host system 410. The reverse look-up entails: searching the assignment database 430 for all serial numbers corresponding/assigned to the name of the trademark owner in question, and correlating all of the serial numbers located from the assignment database 430 as being assigned to the trademark owner in question to the serial numbers in the trademark database 420 to obtain the actual trademarks (i.e., word marks) corresponding to the serial numbers located.

The host system 410 may be configured to continually monitor the trademark database 420 and the assignment database 430 to create and update a consolidated or master database/file(s) on the host system 410 that correlates trademark data with corresponding serial numbers and trademark owners/assignees for ease of access by a user of the host system 410.

The information stored on the trademark database 420 and the assignment database 430, for example, may be stored in a single large file, or broken up into a plurality of files. For example, the USPTO assignment database 430 includes a plurality of files that contain different assignment information that together make up the entire assignment database 430. For example, the assignment database 430 may include: a PROP file that contains serial number data associated with corresponding frame/reel data; and a ASGN file that contains reel/frame data associated with an assignee name corresponding to each reel/frame entry. Accordingly, in order to obtain a serial number associated with an assignee name, both the PROP file and the ASGN file from the assignment database 430 are accessed. Moreover, for example, the trademark database 420 may also include a plurality of data files: a GENV file that contains serial number data, the trademark (i.e., word mark), and filing date data; and a OWNR file that contains serial number data, dates of assignment, assignee name data, and attorney handling data. Accordingly, in order to obtain the trademarks owned by a trademark owner, both the GENV file and the OWNR file from the trademark database 420 are accessed. Additionally, in order to obtain the trademarks assigned to a trademark owner, files from the assignment database 430, as well as the trademark database 420, are accessed and analyzed. Therefore, depending on how the data is arranged and stored on the trademark and assignment databases, the host system 410 may be required to analyze and sort through a plurality of files from one or more databases to extract the necessary information regarding trademarks owned by a trademark owner and trademarks assigned to a trademark owner. As mentioned above, the host system 410 may create and keep a master database locally that is more easily searchable based on its own searches of the trademark and ownership/assignment databases.

According to one embodiment of the present invention, the trademark list may be generated by analyzing a date of assignment for a trademark determined to be assigned to the trademark owner. It is then determined whether the date of assignment of the particular trademark is later than any other assignment dates for the same trademark. If the date of assignment of the trademark assigned to the trademark owner in question is later than any other assignment dates recorded for the particular trademark, then, it is likely that the particular trademark is currently owned by the trademark owner in question, and this particular trademark is included in the trademark list. This analysis may be conducted for each trademark located in any of the above searches.

The host system 410 generates 560 Internet domain names corresponding to the entries in the trademark list. Based on the Internet domain names generated, the host system 410 may search in any one of, for example, the domain information database 480, a gTLD 460 or ccTLD 470 registry, a Top Level domain (TLD) zone file, or a modified zone file to identify 570 whether the Internet domain names generated are available for registration, or whether they have already been registered by someone else. Any Internet domain names generated that are already registered to the trademark owner in question may also be identified, along with any Internet domain names that are already registered with the user. The host system 410 may further allow the user to register any Internet domain names generated that are still available for registration. Moreover, the host system 410 may also allow the user to renew trademark registrations of those trademarks already registered to the user, as well as to transfer Internet domain names from one registry to another.

Embodiments of the present invention provide methods and systems of identifying for a user all of the marks owned by, or assigned to, a particular trademark registrant or application owner, and searching and reporting the incidence of such trademarks in domain names of the Internet. The known information concerning the name of the person or entity to be the subject of the search query is provided by the user. A trademark database is searched to provide results to be used by the user to select the desired trademark owner to be the subject of the search query (the Target). An assignment database may be searched to determine trademarks assigned to the desired trademark owner.

A trademark database, such as TESS, is searched to report all occurrences of trademark applications and registrations owned by the Target (the Trademark Results). The Trademark Results in Internet domain name databases, such as the Network Solutions™ WHOIS database, are searched for occurrences of the Trademark Results within domain name URLs.

A Variations Server, which may be part of the host system 410, for example, may be queried for homonyms and phonetic equivalents of the Trademark Results (the Variations), and the Variations results may be searched in the Internet domain name database. The results that identify which of the Trademark Results and Variations have been registered as domain names and which are available for registration as a domain name (the Domain Results) are provided. The results that may contain hyperlinks to the Web sites for the Internet domain names found, as well as, ownership data for each of the Internet domain names returned may also be provided. The results may enable the user to register all or any portion of the Trademark Results as Internet domain names through a communication link to a registry server.

Preferably, each Internet domain name's corresponding Web site is pinged (i.e., for each URL a HTTP request is made) to determine whether or not the site is active or inactive. Each identified Web site is preferably further crawled to determine the presence of the subject trademark or Variation in the text, hidden text, titles, hyperlinks, detail notes, and images and/or meta tags, etc., or combinations thereof in the Web site or Web page.

The search results are preferably broken down into the identity of domain names relating to each trademark searched, the hyperlink to the Web site identified by each domain name, as well as the hyperlink to the domain name ownership information. Preferably, the search results further provide an indication as to whether the Web site is active or inactive, and/or whether the trademark appears anywhere within the Web site.

Preferably, the search queries and domain name comparisons to be made for a Target are provided on an encrypted connection that is authenticated by a certificate server, such as a Secure Socket Layer (SSL).

The search results may be embodied in a list that is stored with a particular Registrar. Search results obtained by searching outside/external data sources (such as the WHOIS database, for example) may be a plurality of lists stored with a particular Registrar. The ownership and assignment data obtained for each trademark may also be compared with the ownership data stored in a domain name data source, e.g., the WHOIS database, as well. In this manner, one can readily verify whether the ownership/assignment data is consistent with the entity to which a domain name is registered. The search results containing the trademark lists may be directed to individuals and entities that have accounts with a search service, which may be a Registrar, and the trademark lists may be kept by the search service/Registrar. Accordingly, it is possible that each different Registrar or search service may maintain different search results and trademark lists.

In summary, embodiments of the present invention relate to methods and systems of inputting at least one Target to be searched, searching and reporting the incidence of at least one trademark belonging or assigned to the Target, and searching at least one identified trademark or Variation to registered domain names. A search string is created that preferably includes not less than one Target. The trademark database servers are queried to return the Trademark Results, identifying the trademark application(s) and registration(s) corresponding to such Target(s). A second search string is created that preferably includes at least one trademark from the Trademark Results. The domain name database servers are then queried to return the Domain Results, identifying any registered domain name registration(s) corresponding to preferably at least one trademark of the second search string. A third search string is created from the Domain Results that includes any domain name registration(s) and any available domain names corresponding to preferably at least one trademark of the second search string.

The method preferably includes accessing a Web page corresponding to at least one domain name and searching for incidences of the corresponding marks from the second search string. Then, the search results of Trademark Results within the Web page are provided within the Web page. The method further preferably includes comparing the variations database servers and concatenating the results to the corresponding trademarks of the Trademark Results to form search strings used to query the domain name database servers.

It is to be understood that the exemplary methodology described herein and shown in the drawings represent only a presently preferred embodiment of the invention. As those skilled in the art will appreciate, the present invention is suitable for use in a variety of different applications, other than matching trademarks with domain names. For example, the present invention may be utilized in matching any database to registered domain names, such a database of copyrighted works and/or authors, famous names, movie titles, and the like.

Various modifications and additions may be made to the described embodiment without departing from the spirit and scope of the invention. For example, various different protocols for defining and implementing the exclusion of certain data from the report templates may be included. Additionally, various different protocols for defining and implementing the sorting and compilation of data contained in the report templates may also be included. Thus, these and other modifications and additions may be implemented to adapt the present invention for use in a variety of different applications. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A system to correlate trademark data to Internet domain name data, comprising:
a user system having a user interface; and
a host system in communication with the user system, wherein the host system executes a software application adapted to receive a name of a trademark owner, to create a search string including at least the name of the trademark owner, to search for trademarks owned by the trademark owner based on the search string, to search for trademarks assigned to the trademark owner based on the search string, to generate a trademark list including the trademarks owned by the trademark owner and the trademarks assigned to the trademark owner located, to generate domain names corresponding to the trademark list, and to identify whether the domain names generated are available for registration.

2. The system according to claim 1, wherein the software application is further adapted to register at least one of the domain names identified as available for registration.

3. The system according to claim 1, wherein the software application is further adapted to analyze a date of assignment of a trademark assigned to the trademark owner, to determine whether the date of assignment of the trademark is later than any other assignment dates for the trademark, and to include the trademark in the trademark list if the date of assignment of the trademark assigned to the trademark owner is later than any other assignment dates for the trademark.

4. The system according to claim 1, wherein the software application is further adapted to identify any domain names already registered to the trademark owner.

5. The system according to claim 1, wherein the software application is further adapted to search a Top Level Domain (TLD) zone file to determine whether the domain names generated are available for registration.

6. The system according to claim 1, wherein the software application is further adapted to search a Top Level Domain (TLD) registry to confirm whether the domain names generated are available for registration.

7. The system according to claim 1, wherein the software application is further adapted to search a Top Level Domain (TLD) zone file to determine whether the domain names generated less a TLD extension are available for registration.

8. The system according to claim 1, wherein the software application is further adapted to search a Top Level Domain (TLD) registry to confirm whether the domain names generated with a TLD extension are available for registration.

9. The system according to claim 1, wherein the software application is further adapted to receive information relating to the trademark owner to be searched, and to provide names of potential trademark owners based on the information received for selection by a user of the trademark owner to be searched.

10. The system according to claim 1, wherein the software application is further adapted to search for homonyms and phonetic equivalents of the located trademarks owned by the trademark owner, and to generate the trademark list including the homonyms and the phonetic equivalents of the located trademarks owned by the trademark owner.

11. The system according to claim 1, wherein the software application is further adapted to search for homonyms and phonetic equivalents of the trademarks located assigned to the trademark owner, and to generate the trademark list including the homonyms and the phonetic equivalents of the located trademarks assigned to the trademark owner.

12. The system according to claim 1, wherein the software application is further adapted to search an assignment database utilizing the name of the trademark owner for a serial number of a trademark assigned to the trademark owner, to search a trademarks database utilizing the serial number located for the trademark corresponding to the serial number, and to include the trademark in the trademark list.

13. The system according to claim 1, wherein the user interface is a Web browser software application.

14. The system according to claim 1, wherein the user system communicates with the host system via the Internet.

15. The system according to claim 1, wherein the host system further includes an Internet server, a data server, and a file server.

16. The system according to claim 1, wherein the host system is in communication with at least one of a trademark database and an assignment database.

17. The system according to claim 1, wherein the host system is in communication with at least one of a general Top Level Domain (gTLD) registry and a country code Top Level Domain (ccTLD) registry.

18. A program code storage device, comprising:
a machine-readable storage medium; and
machine-readable program code, stored on the machine-readable storage medium, having instructions to
receive a name of a trademark owner;
create a search string including at least the name of the trademark owner;
search for trademarks owned by the trademark owner based on the search string;
search for trademarks assigned to the trademark owner based on the earch string;
generate a trademark list including the trademarks owned by the trademark owner and the trademarks assigned to the trademark owner located;
generate domain names corresponding to the trademark list; and
identify whether the domain names generated are available for registration.

19. The program code storage device according to claim 18, wherein the machine-readable program code further includes instructions to register at least one of the domain names identified as available for registration.

20. The program code storage device according to claim 18, wherein the machine-readable program code further includes instructions to:
analyze a date of assignment of a trademark assigned to the trademark owner;
determine whether the date of assignment of the trademark is later than any other assignment dates for the trademark; and
include the trademark in the trademark list if the date of assignment of the trademark assigned to the trademark owner is later than any other assignment dates for the trademark.

21. The program code storage device according to claim 18, wherein the machine-readable program code further includes instructions to identify any domain names already registered to the trademark owner.

22. The program code storage device according to claim 18, wherein the machine-readable program code further includes instructions to search a Top Level Domain (TLD) zone file to determine whether the domain names generated are available for registration.

23. The program code storage device according to claim 18, wherein the machine-readable program code further includes instructions to search a Top Level Domain (TLD) registry to confirm whether the domain names generated are available for registration.

24. The program code storage device according to claim 18, wherein the machine-readable program code further includes instructions to search a Top Level Domain (TLD) zone file to determine whether the domain names generated less a TLD extension are available for registration.

25. The program code storage device according to claim 18, wherein the machine-readable program code further includes instructions to search a Top Level Domain (TLD) registry to confirm whether the domain names generated with a TLD extension are available for registration.

26. The program code storage device according to claim 18, wherein the machine-readable program code further includes instructions to:
receive information relating to the trademark owner to be searched; and
provide names of potential trademark owners based on the information received for selection by a user of the trademark owner to be searched.

27. The program code storage device according to claim 18, wherein the machine-readable program code further includes instructions to:
search for homonyms and phonetic equivalents of the located trademarks owned by the trademark owner; and
generate the trademark list including the homonyms and the phonetic equivalents of the located trademarks owned by the trademark owner.

28. The program code storage device according to claim 18, wherein the machine-readable program code further includes instructions to:
search for homonyms and phonetic equivalents of the trademarks located assigned to the trademark owner; and
generate the trademark list including the homonyms and the phonetic equivalents of the located trademarks assigned to the trademark owner.

29. The program code storage device according to claim 18, wherein the machine-readable program code further includes instructions to:
search an assignment database utilizing the name of the trademark owner for a serial number of a trademark assigned to the trademark owner;
search a trademarks database utilizing the serial number located for the trademark corresponding to the serial number; and
include the trademark in the trademark list.
